(19) United States
(12) Patent Application Publication
(10) Pub. No.: US 2005/0167639 A1
(43) Pub. Date: Aug. 4, 2005

(54) Electronic material composition, electronic product and method of using electronic material composition

(76) Inventors: Takuro Hoshio, Taito-ku (JP); Takahiro Samata, Taito-ku (JP); Koichiro Wada, Taito-ku (JP); Hideki Ogawa, Taito-ku (JP); Shigeru Ishida, Hiratsuka-shi (JP); Atsushi Yamada, Hiratsuka-shi (JP)

Correspondence Address: BIRCH STEWART KOLASCH & BIRCH, PO BOX 747, FALLS CHURCH, VA, 22040-0747, US

(21) Appl. No.: 10/514,499

(22) PCT Filed: Jan. 29, 2004
(86) PCT No.: PCT/JP04/00837

(30) Foreign Application Priority Data
Jan. 30, 2003 (JP) 2003-21270

(51) Int. Cl. H01C 1/00

(52) U.S. Cl. 252/512

(57) ABSTRACT

Disclosed are an electronic material composition, an electronic device to be obtained through the employment of this electronic material composition, and a method of using this electronic material composition, wherein the electronic material composition is featured in that, even if the electronic material composition is employed as one-pack type, the changes with time of viscosity would be such that would not bring about any substantial problem in practical use, and even if the electronic material composition is exposed to fluctuations in ambient temperature, there is little possibility of generating cohesive failure or peeling fracture, thereby making it possible to enhance the handling properties of the electronic material composition in a packaging step without any possibility of giving damage to the external appearance and to prevent the deterioration of magnetic/electric properties that can be improved through the provision of a packaging body to an electronic device even if the content of an inorganic filler in a cured coated layer is increased. This electronic material composition comprises epoxy resin, and a terminal carboxylic group modified polyether compound acting as a curable component.

This application is based on International Application No. PCT/JP2004/000837 filed on Jan. 29, 2004 which claims priority to Japanese Patent application No 2003-21270 filed on Jan. 30, 2003.

### TECHNICAL FIELD

This invention relates to an electronic material composition comprising a special polyether compound as a curable component, to electronic parts to be obtained through the employment of this electronic material composition, and to a method of using this electronic material composition.

### BACKGROUND ART

Curable resins such as epoxy resin, etc. are utilized as an important component of an electronic material composition which can be used as it is or as a mixture with electronic material powder such as ferrite powder, metallic powder, etc. Electric materials such as these resins and electronic material powder are widely utilized mainly as a raw material such as a packaging material, etc. in the manufacture of electronic parts or components.

For example, the curable resins can be employed as a packaging material, as shown in FIG. 1, in a wound chip coil 1 which comprises a core 2 having a pair of flange portions at the opposite ends thereof, a winding 3 wound around a central annularly recessed portion, outer terminal electrodes 4, 4 attached to the flange portions formed at the opposite ends of the core 2, and an packaging portion 5 made of a covering material and covering the winding 3, the covering material being formed using the curable resins. By the way, this wound chip coil 1 is mounted on a printed wiring board 6 through soldering lands 6a, 6a of circuit pattern, wherein the aforementioned electrodes 4, 4 are bonded to the soldering lands 6a, 6a respectively, by making use of solder 7. Although not shown in FIG. 1, other kinds of chips can be mounted on predetermined soldering lands in the same manner as described above, and the printed wiring board 6 including these chips is also entirely covered by a packaging material 8.

There is also known, as a packaging material of electronic parts, e.g. as an electronic material composition for covering an IC chip, a composition containing, as main components, epoxy resin and a reactive liquid rubber such as terminal carboxylic polybutadiene, wherein flexible epoxy resin which is modified using such a reactive liquid rubber is said to be excellent in heat shock property and humidity resistance (JP Laid-open Patent Publication (Kokai) No.4-335556 (1992)).

It is known that when an electronic material composition containing polysulfide-based polymer is employed for the manufacture of a covering body for the aforementioned wound chip coil, a molded body such as a core and the like, and the filling body, covering body, outer electrodes or junctions of electronic parts, the resultant products thus obtained are not only capable of withstanding thermal stress to be generated due to abrupt changes in temperature or a difference in linear expansion coefficient, but also capable of alleviating such a thermal stress. Additionally, the products thus obtained are excellent in flexibility, and hence substantially free from the generation of cracks (JP Laid-open Patent Publication (Kokai) No.2001-11325).

However, the electronic material compositions to be employed especially as a packaging material for a wound chip coil as described in any of the aforementioned patent publications are mainly constituted by so-called two-pack type wherein two kinds of liquids, i.e. a liquid containing a curing component, and a liquid containing a component to be cured are separately manufactured and are combined with each other immediately before actual use. Therefore, it takes time in the manufacture as well as in the use of these electronic material compositions. Moreover, if there is any remainder left over after the use of these electronic material compositions, it cannot be re-used in most of the cases since a reaction is permitted to proceed in this remainder portion, and hence there is no other way than to discard this remainder portion. As described above, since there is much possibilities of wasting the electronic material composition according to the prior art, it is now earnestly desired to develop an electronic material composition which is one-pack type not only in the manufacture thereof, but also in the storage and actual use thereof.

Additionally, the electronic material composition is required to have the following features, which the conventional electronic material compositions have failed to sufficiently achieve or have been demanded to make further improvement. The following features are demanded to improve also in the electronic material compositions to be employed in the manufacture of other kinds of molded electronic components, etc.

(1) Improvement of the Reliability that the Fracture or Peeling of Product would not be Generated even if the Product is Subjected to Fluctuations in Ambient Temperature:

A chip-type inductor component such as the aforementioned wound chip coil is constructed such that a pair of electrodes attached to the opposite ends of the chip coil are bonded to the soldering lands of a circuit board. On this occasion, fused solder heated to a temperature of not less than 250° C. is quenched after the application of the fused solder to the joint portion, thus subjecting the inductor component to a high temperature and then to an ambient temperature. Further, in order to ensure that an electronic part-mounted circuit board to be mounted on a car for example is free from being damaged of its function even if the region where the circuit board is employed is a tropical region or a cold region, the circuit board is subjected to so-called heat cycle test wherein the performance of the circuit board is investigated in an atmosphere where a cycle of a high temperature and a low temperature is repeatedly applied. Therefore, a packaging material is required to have features to withstand these heat shocks.

When an electronic material composition is to be employed as a packaging material, the electronic material composition comprising a mixture of a resin component and a solvent is coated and cured. In this case, the cured layer thus obtained is required to have various properties that even if the cured layer is exposed to fluctuations of ambient temperature as described above, it can be easily extended or shrunk in conformity with the fluctuations of ambient temperature, thus making it possible to prevent the generation of strain and hence the generation of stress (stress due to thermal strain) as well as the generation of residual stress resulting from such a strain, to prevent the generation of cohesive failure or the fracture of the cured layer at the interior thereof due to failure to resist the residual stress, and to prevent the generation of peeling fracture or peeling of winding portion for instance in the case of the aforementioned wound chip coil. In the case of the inductor component in particular where the packaging body thereof is formed using a composite material comprising an inorganic filler such as ferrite powder, Al₂O₃ powder, etc. and a resin component as in the case of the aforementioned wound chip coil, it is possible to improve the inductance value (L value), to lower the electric resistance under direct current, or to raise the high frequency of self-resonance frequency, thus making it possible to proportionally miniaturize the chip coil, so that the provision of such a packaging body is preferable in terms of improving magnetic and electric characteristics. However, if the composite material is formed using, together with a resin component, a relatively high content of an inorganic filler such as ferrite powder, Al₂O₃ powder, etc., the tenacity, threshold breaking extension (extension immediately before the breakdown in a tension test), and strength of the packaging body would be caused to deteriorate considerably as compared with the packaging body formed using only resin without inclusion of the aforementioned inorganic filler. As a result, cohesive failure or peeling fracture due to the stress resulting from thermal strain is more likely to occur in the case of the packaging body formed using the aforementioned composite material. Therefore, it is now required to provide a packaging body having characteristics which are capable of overcoming the aforementioned problems.

(2) Improvement in Handling Properties in the Step of Packaging:

In the case of the inductor component accompanied with a packaging body, for example such as the aforementioned wound chip coil, the process of forming the packaging body thereof is performed in such a manner that materials including a curable resin, etc. are formed into a coating material, which is then coated on the surface of winding and dried to semi-cure the resin. The resultant semi-cured component is then thrust into a mold to undergo the step of so-called thermal shaping, the component thus formed being subsequently heated again to accomplish the curing of the resin. During the process of thrusting the resin into a mold after the resin has been semi-cured, mainly the unreacted portion of the resin is permitted to bleed out with time, thus rendering the surface of coated layer to become sticky. As a result, the chip coil is caused to adhere with the mold, thereby making it impossible to thrust the chip coil fully into the mold. On the other hand, even if it is possible to thrust the chip coil fully into the mold, mainly the unreacted portion of the resin is permitted to bleed out in the same manner as described above in spite of the fact that the resin is permitted to thermally cure in the step of shaping due to the effect of restoring pressure if the mold is made of rubber. Therefore, when the chip coil is taken out of the mold as it is and transferred to the next step or a step of forming electrodes and allowed to put together with the same one, a plurality of such chip coils are caused to adhere with each other, thus making it impossible to smoothly accomplish the electrode-forming step. It is therefore required to provide a packaging body which is capable of overcoming the aforementioned problems.

Further, since the state where a resin is semi-cured is identical with a state where the curing of the resin has been taken place slightly, if the degree of this semi-curing is too low, this semi-cured resin would be stripped away on the occasion of thrusting the chip coil into a mold by the brim of inlet port of the mold. On the other hand, if the degree of this semi-curing is too high, although it may be possible to thrust the chip coil into the mold, the formability of the packaging body would be deteriorated because of the poor fluidity of the resin, thus making it impossible to obtain a smooth shaped surface. Therefore, it is now required to develop an electronic material composition which is capable of controlling the degree of curing. More specifically, it is required to develop an electronic material composition which is capable of easily and uniformly determining the timing of thrusting a semi-cured packaging body into a mold after being admitted as successful in so-called dry to touch test wherein an inner surface of finger is contacted to a coated layer to see if the coated layer sticks to the inner surface of finger to thereby investigate so-called tack-free condition or a state indicating no stickiness.

(3) Improvement on the External Appearance of Packaging Body:

The electronic material composition to be employed as a packaging material to be applied onto the winding of a wound chip coil for instance is usually employed by way of coating. Therefore, when this coating is performed in air atmosphere, air is permitted to be entrapped in the coated layer. In particular, if the substrate to be coated is formed of a winding having a projected/recessed surface, the possibility of entrapping air in the coated layer is increased, thus allowing the coated layer to include voids therein. When such a coated layer is heated to semi-cure the resin component thereof in a curing oven, the voids are permitted to expand. Furthermore, as the wettability between the underlying substrate and the resin component of the coated layer is getting inferior, the resin component would become increasingly poor in fluidity, so that it would become very difficult to fill the expanded voids with the resin component, thus allowing the voids to leave in the coated layer, some of the voids being allowed to exposed on the surface of the coated layer. When the curing of the coated layer is permitted to proceed as it is, the voids would become pinholes. Even if this resin component is softened through the heating thereof in the subsequent step of shaping, it would be impossible to sufficiently fill the pinholes with this softened resin component. As a result, the pinholes are permitted to leave behind, thus giving rise to the deterioration of yield due to the defects in external appearance of the product. Therefore, the electronic material composition to be employed as a packaging material is required to be free from the aforementioned problems.

Therefore, a first object of the present invention is to provide a one-pack type electronic material composition, an electronic device to be obtained through the employment of this one-pack type electronic material composition, and a method of using this one-pack type electronic material composition.

A second object of the present invention is to provide an electronic material composition which is capable of obviating the generation of cohesive failure or peeling fracture even if the electronic material composition is subjected to fluctuation in ambient temperature, an electronic device to be obtained through the employment of this electronic material composition, and a method of using this electronic material composition.

A third object of the present invention is to provide an electronic material composition which is capable of improving the easiness in handling in the step of packaging, etc., an electronic device to be obtained through the employment of this electronic material composition, and a method of using this electronic material composition.

A fourth object of the present invention is to provide an electronic material composition which is capable of obtaining a shaped surface without deteriorating the external appearance of the surface, an electronic device to be obtained through the employment of this electronic material composition, and a method of using this electronic material composition.

A fifth object of the present invention is to provide an electronic material composition which is capable of substantially preventing, even if the content of an inorganic filler in a cured coated layer is increased, the deterioration of magnetic/electric properties that can be improved through the provision of a packaging body to an electronic device, an electronic device to be obtained through the employment of this electronic material composition, and a method of using this electronic material composition.

### DISCLOSURE OF INVENTION

The present invention has been made with a view to overcome the aforementioned problems, and therefore, there is provided (1) an electronic material composition which essentially comprises an epoxy-based curable resin having epoxy group; and a terminal carboxylic group modified polyether compound acting as a curable component which is capable of reacting with said epoxy group.

According to the present invention, there is also provided (2) an electronic material composition which essentially comprises a butadiene-based polymer modified epoxy resin having carboxylic group as said epoxy-based curable resin having epoxy group; and a terminal carboxylic group modified polyether compound acting as a curable component which is capable of reacting with said epoxy group.

According to the present invention, there is also provided (3) the electronic material composition as set forth in the aforementioned item (1) or (2), which further comprises ultra-fine silica gel powder.

According to the present invention, there is also provided (4) the electronic material composition as set forth in any one of the aforementioned items (1) to (3), wherein an epoxy curing agent which is different from the terminal carboxylic group modified polyether compound is included as the curable component.

According to the present invention, there is also provided (5) the electronic material composition as set forth in the aforementioned item (4), wherein said epoxy curing agent is phenol novolac resin.

According to the present invention, there is also provided (6) the electronic material composition as set forth in any one of the aforementioned items (1) to (5), which further comprises electronic material powder.

According to the present invention, there is also provided (7) the electronic material composition as set forth in the aforementioned item (6), wherein said electronic material powder is magnetic powder.

According to the present invention, there is also provided (8) the electronic material composition as set forth in any one of the aforementioned items (1) to (7), wherein a formed body to be obtained through application of an electronic material composition to an electronic product is: a molded body made of a molding material; a filler body made of a filler material; a covering body made of a covering material; an electrode made of an electrode material; or a junction body made of a junction material.

According to the present invention, there is also provided (9) an electronic product comprising the molded body, the filler body, the covering body, the electrode, or the junction body as set forth in the aforementioned item (8).

According to the present invention, there is also provided (10) the electronic product as set forth in the aforementioned item (9), wherein said electronic product is a wound chip coil having a packaging body, and said covering body is the packaging body applied onto and covering a winding of wound chip coil.

According to the present invention, there is also provided (11) a method of using an electronic material composition, wherein the electronic material composition as set forth in any one of the aforementioned items (1) to (8) is used and set to a semi-cured state to obtain an electronic product having a semi-cured molded body, filler body, covering body, electrode, or junction body, and then the electronic material composition is completely cured to obtain an electronic product having a cured molded body, filler body, covering body, electrode, or junction body.

According to the present invention, there is also provided (12) the method of using an electronic material composition as set forth in the aforementioned item (11), wherein the electronic product having a semi-cured covering body is allowed to dry to a state of dry to touch and then thermally shaped by making use of a mold to obtain the electronic product having a cured packaging body.

According to the present invention, there is also provided (13) the method of using an electronic material composition as set forth in the aforementioned item (12), wherein the electronic product having a semi-cured covering body is formed using an electronic material composition containing an ester-based solvent and a petroleum solvent at a ratio ranging from 0:100% to 100:0% by mass.

### BRIEF DESCRIPTION OF DRAWINGS

FIG. 1 is a partial cross-sectional view of the printed substrate-mounted electronic product as set forth in a first example of the electronic product according to the present invention;

FIG. 2 is a cross-sectional view of a casing as set forth in a second example of the electronic product according to the present invention;

FIG. 3 is a perspective view of an LC laminated composite electronic product as set forth in a third example of the electronic product according to the present invention;

FIG. 4 shows a radiation noise prevention cable as set forth in a fourth example of the electronic product according to the present invention; and

FIG. 5 is a perspective view of part of the outer wall of a building as set forth in a fifth example of the electronic product according to the present invention.

### BEST MODE FOR CARRYING OUT THE INVENTION

As for “epoxy-based curable resin having epoxy group” in the present invention, it is possible to employ bisphenol type epoxy resin such as bisphenol A-type epoxy resin, etc.; novolac type epoxy resin such as phenol novolac type epoxy resin, etc.; and other known epoxy resins. Further, it is also possible to employ butadiene polymer-modified epoxy resin having carboxylic group that can be obtained through a reaction between these epoxy resins and a butadiene polymer having carboxylic group. As for the butadiene polymer of the butadiene polymer having carboxylic group, it is possible to employ acrylonitrile-butadiene rubber, styrene-butadiene rubber and polybutadiene. These compounds may be in a state of liquid. In particular, it is preferable to employ acrylonitrile-butadiene rubber-modified epoxy resin having carboxylic group that can be obtained through a reaction between acrylonitrile-butadiene rubber having carboxylic group and epoxy resin. It is preferable in this case to employ those having carboxylic group at a terminal of the molecule.

The butadiene polymer-modified epoxy resin having carboxylic group can be obtained, for example, according to the known method of manufacturing acrylonitrile-butadiene rubber-modified epoxy resin having carboxylic group, and hence other kinds of butadiene polymer-modified epoxy resins having carboxylic group can be obtained in conformity with this known method.

By the term of “terminal carboxylic group modified polyether compound” according to the present invention, it represents polyether compounds having carboxylic group at their terminals their molecules. For example, it can be obtained through a reaction between a terminal hydroxyl group of polyether polyol and an acid anhydride to thereby coupling them through an ester linkage, thus introducing carboxylic group therein. As for the number of terminal carboxylic group, it may be one or more than one. Further, other than introducing the carboxylic group into a terminal of the compound, the carboxylic group may be introduced, in a similar manner, into a middle portion of the molecular chain.

As for the polyether polyol, it may be a polymer which can be obtained through an addition polymerization of at least one compound, i.e. one or more kinds of compounds selected from alkylene oxide such as ethylene oxide, propylene oxide, butylene oxide, etc.; aromatic oxide such as styrene oxide, etc.; and a cyclic ether compound such as alicyclic oxide such as tetrahydrofuran, etc. Specific examples of the polyether polyol include polyalkylene glycols such as polyethylene glycol, polypropylene glycol, an addition copolymer composed of ethylene glycol and propylene glycol, etc. Of course, it is possible to employ other kinds of polyether polyols.

Additionally, it is also possible to employ polyether polyols that can be obtained through the addition polymerization of one or more kinds of compounds having two of more active hydrogen atoms in one or more kinds of the aforementioned cyclic ether compounds. As for the compounds having two of more active hydrogen atoms, they include polyhydric alcohol, amines, alkanol amines, etc.

As for specific examples of polyhydric alcohol, they include ethylene glycol, diethylene glycol, propylene glycol, dipropylene glycol, glycerin, 1,1,1-trimethylol propane, 1,2,5-hexane triol, 1,3-butane diol, 1,4-butane diol, 4,4′-dihydroxyphenylpropane, 4,4′-dihydroxyphenylmethane, pentaerythritol, etc. As for specific examples of amines, they include ethylene diamine, propanol amine, etc. As for specific examples of alkanol amines, they include ethanol amine, propanol amine, etc.

In the case of obtaining terminal carboxylic group modified polyether compounds through a reaction between polyether polyol and acid anhydride, specific examples of acid anhydride include anhydride of polyhydric carboxylic, such as succinic acid, glutamic acid, adipic acid, azelaic acid, sebacic acid, decamethylene carboxylic acid, phthalic acid, maleic acid, trimellitic acid, pyromellitic acid, tetrahydrophthalic acid, hexahydrophthalic acid, methylhexahydrophthalic acid, etc. In particular, it is preferable, in terms of curability in relationship with epoxy resin, to employ a terminal carboxylic group modified polyether compound to be obtained through the employment of trimellitic acid.

With respect to the molecular weight of the terminal carboxylic group modified polyether compounds to be obtained in this manner, it should preferably be within the range of 800 to 8000, more preferably 800 to 5000 in weight average molecular weight. By confining the molecular weight within this range, it would become possible to improve the tenacity and heat resistance of the terminal carboxylic group modified polyether compounds.

Since the terminal carboxylic group modified polyether compounds are low in reactivity with the epoxy group of epoxy-based curable resin at ambient temperature and also since a solution containing both of these materials is relatively low in viscosity increase with time, these materials can be employed as so-called one-pack composition.

The electronic material composition according to the present invention should preferably contain ultra-fine silica gel in addition to the epoxy-based curable resin having epoxy group and the terminal carboxylic group modified polyether compound. As for specific examples of the ultra-fine silica gel, it is possible to employ RY200S (Nippon Aerogel Co., Ltd.)

As for the mixing ratio between the epoxy-based curable resin having epoxy group and the terminal carboxylic group modified polyether compound, it may be confined within the range of 99:1 to 1:99, more preferably 90:10 to 40:60 in mass ratio. As for the mixing ratio of the ultra-fine silica gel, it should preferably be confined within the range of 1 to 70% by mass based on the resin component.

When a cured resin is formed through a reaction between the terminal carboxylic group modified polyether compound and the epoxy-based curable resin having epoxy group, or when a cured resin is formed by additionally incorporating ultrafine silica gel into the reaction mixture, the glass transition temperature Tg or Young's modulus of the cured resin can be lowered, thus providing the cured resin with flexibility. As a result, the residual stress in the cured resin can be alleviated. This tendency would become more prominent especially when the aforementioned ultrafine silica gel is incorporated into the reaction mixture, thus making it possible to enhance the various properties described in the aforementioned item (1), in particular, the heat cycle resistance for withstanding a heat cycle test. Particularly, as a specific example of the aforementioned epoxy-based curable resin having epoxy group, when butadiene polymer-modified epoxy resin having carboxylic group, especially, acrylonitrile butadiene rubber-modified epoxy resin having carboxylic group is employed singly or in combination with the aforementioned epoxy resin, it is possible, especially in the case of the former one, to further enhance the heat cycle resistance. Even in the case of the latter one also, the tenacity of cured resin can be enhanced due to the rubber modification, thus making it possible to further improve the heat cycle resistance.

By setting each of the aforementioned components to a suitable range, the aforementioned properties can be more excellently exhibited.

The electronic material composition according to the present invention may include, in addition to the aforementioned epoxy-based curable resin having epoxy group and terminal carboxylic group modified polyether compound, phenolic novolac-based resin such as phenolic novolac resin, cresol novolac resin, etc., thus making it possible to reduce the quantity of employing the aforementioned terminal carboxylic group modified polyether compound, to suppress the flexibility of the cured resin, and to adjust the hardness of the cured resin. At the same time, when the aforementioned ultrafine silica gel is further included therein and a specific kind of solvent is employed at a specific ratio, the properties described in the aforementioned item (2) can be enhanced.

With respect to the solvent among them, it is possible to employ a mixed solvent consisting of an ester-based solvent having a boiling point of 100 to 200° C. such as 2-butoxyethyl acetate and a petroleum solvent having a boiling point of 100 to 200° C. such as petroleum hydrocarbon compounds, the mixing ratio of them ranging from 0:100 to 100:0 in mass ratio. It is possible, through the adjustment of the solvent-volatilization speed of this mixed solvent, to suppress the bleedout with time of unreacted resin component under a semi-cured state of the electronic material composition after the coating thereof on a chip component such as a wound chip coil. The reason for this may be attributed, to some extent, to the fact that although the influence on the bleedout by the volatilization of each of the solvents is relatively great, when a polar (to some extent) solvent and a nonpolar (to some extent) solvent are mixed together and employed as a mixed solvent, the desorption of solvents from resin component can be controlled. The employment of this kind of mixed solvent may be required to provide coating properties while providing solubility to other kinds of components.

With respect to the employment of the ultra-fine silica gel, although the mixing ratio thereof to other kinds of components may be as described above, the employment of the ultra-fine silica gel is advantageous in the following respect. Namely, when a chip component packaged with the aforementioned semi-cured resin is thrust into a mold especially made of rubber, a great magnitude of restoring pressure is imposed onto the semi-cured resin, thereby permitting unreacted resin component to squeeze out, thus generating bleedout. In this case, this bleedout component can be adsorbed by the ultra-fine silica gel, thus making it possible to control the tackiness of the surface of formed component and hence to prevent the formed component from adhering onto the mold. As a result, the handling properties of the formed component for transferring it to the next step can be enhanced.

Further, although the phenolic novolac resin can be employed at a ratio of 0 to 60 parts by mass, preferably 40 to 50 parts by mass per 100 parts by mass of epoxy-based curable resin having epoxy group, when this resin component is permitted to exist on the surface of packaging body in the aforementioned semi-cured state of resin, the surface hardness of the packaging body would be increased at the ordinary temperature, so that there is little possibility of causing the semi-cured resin to be stripped away by the brim of inlet port of a mold on the occasion of thrusting the chip component packaged with the semi-cured resin into the mold. Moreover, this resin component can be softened and fluidized by the heat on the occasion of thermally shaping the packaged body, thereby making it possible to satisfactorily perform the shaping without damaging the profiling in the shaping step.

The electronic material composition according to the present invention may include, in addition to the aforementioned epoxy-based curable resin having epoxy group and terminal carboxylic group modified polyether compound, a filler. As for specific examples of the filler, they include powdery inorganic materials such as silica, alumina, ferrite, silver, barium titanate, nickel, etc. Powdery electronic materials such as magnetic material, conductive material, etc. are also capable of functioning as a filler and hence are useful as a filler. Among them, clayey powder such as quaternary ammonium cation-modified montmorillonite and the like are preferable for use as a filler. A filler made of the clayey powder should preferably be included at a ratio of 0 to 10 parts by mass, more preferably 1 to 4 parts by mass per 100 parts by mass of the epoxy-based curable resin having epoxy group.

As compared with phenolic resin, the terminal carboxylic group modified polyether compound is capable of enabling the reaction thereof with the epoxy-based curable resin having epoxy group to proceed more gently, it is possible to derive excellent fluidity at the moment of enabling the semi-cured packaging body to temporarily soften by the heating at the step of shaping. As a result, any pinhole that may exist on the surface of the semi-cured packaging body can be filled with this softened material of resin, etc. Further, the filler, especially inorganic clayey filler is also caused to fluidize as it is swelled by the heating of the semi-cured resin, so that the recessed portions of the projected/recessed surface of winding (where a wound chip coil is to be packaged) can be filled with the filler and flattened. As a result, the wettability of the packaging material to the underlying substrate consisting of the winding is apparently enhanced, thus making it possible to considerably minimizing the generation of pinhole that may be liable to be generated due to the existence of the recessed portions and also making it possible to miniaturize the size of the pinhole.

In the present invention, although the resin material composition containing the aforementioned components can be employed as it is as an electronic material composition, this resin material composition may be mixed with powdery electronic material, thereby rendering it useful as an electronic material composition such as a conductive material composition, a magnetic material composition, etc.

When the aforementioned components (where the filler is not employed, the filler is excluded, the same with other kinds of additives) are employed as a mixture with a powdery magnetic material, 0 to 60% by volume of the powdery magnetic material can be mixed with 40 to 100% by volume of the aforementioned components. Further, if required, other kinds of resins or solvents as well as other kinds of additives can be added to the aforementioned compositions (substantially the same in the case of the aforementioned resin material composition), thereby obtaining a magnetic material composition. As for the powdery magnetic material, various kinds of powdery ferrite can be employed. When the aforementioned components are employed as a mixture with a powdery conductive material, 0 to 60% by volume of the powdery conductive material can be mixed with 40 to 100% by volume of the aforementioned components. Further, if required, other kinds of resins or solvents as well as other kinds of additives can be added to the aforementioned compositions, thereby obtaining a conductive material composition. As for specific examples of the powdery conductive material, they include silver, copper, aluminum, other kinds of metals and carbon black. It is also possible to employ fullerene (C60 type and C70 type carbon). By the way, the aforementioned expression of “0 to 60% by volume” may be expressed also as “60% by volume or less” or “not more than 60% by volume”. Other expressions such as “0-” may be interpreted in the same way. By the way, as described above, the powdery magnetic material as well as the powdery conductive material can be considered as a filler.

The electronic material composition according to the present invention may be employed either by mixing the aforementioned epoxy-based curable resin having epoxy group and terminal carboxylic group modified polyether compound with a powdery electronic material such as a powdery magnetic material or a powdery conductive material, or without mixing them with the aforementioned powdery electronic material such as a powdery magnetic material or a powdery conductive material. With respect to the former case, the electronic material composition can be employed, through the selection of a suitable kind of powdery electronic material, as a covering material (packaging material), a molding material, an electrode material, a junction material or a filler. With respect to the former case, some kinds of the electronic material composition can be employed for any of the aforementioned purposes. For example, the composition may be employed as a packaging material for a wound chip coil.

As for specific examples of the electronic components to which these electronic compositions are applicable, they include an inductor such as the aforementioned wound chip coil, an electronic component-mounting circuit substrate, etc., wherein these electronic compositions can be employed as a packaging material. In the case where the electronic composition is applied to a chip type electronic component, the electronic component can be formed or molded by any kind of methods including a thermally shaping method wherein a coated body of packaging material is thrust into a mold formed of a heat resistant rubber plate provided with a plasmatic recessed portion as in the case of the aforementioned wound chip coil, an injection method, a transfer method, a rubber mold method or a casting method.

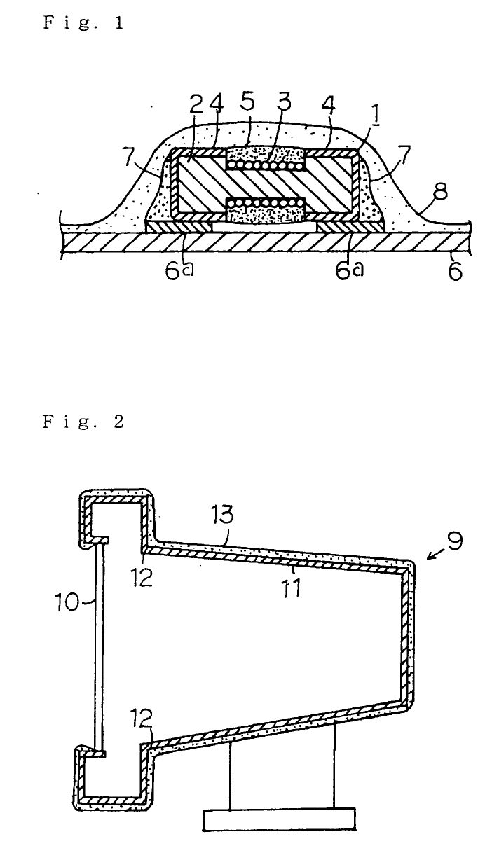

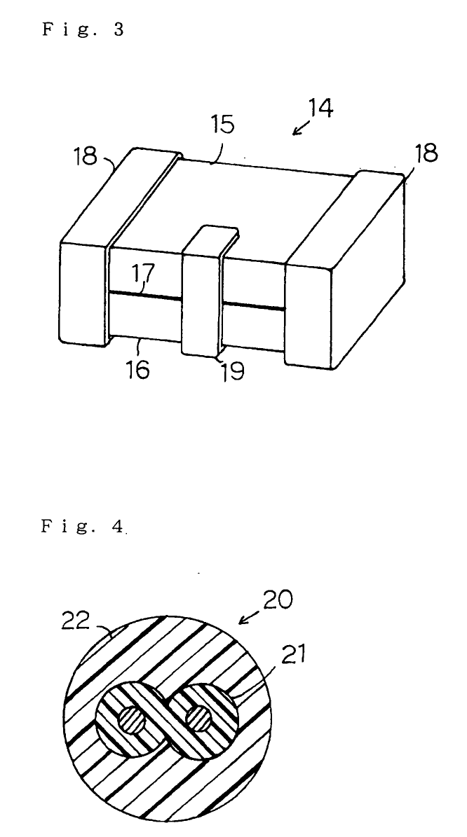

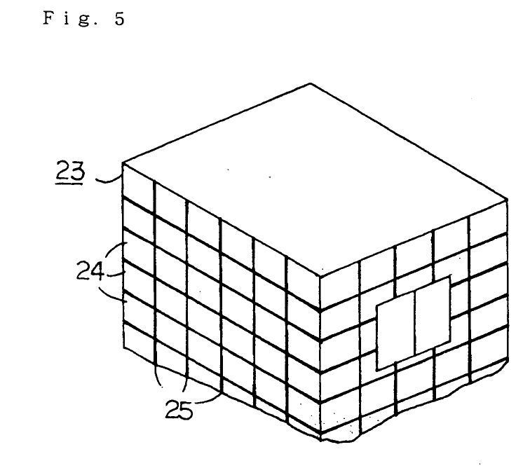

As another example of the electronic component to which these electronic compositions are applicable, there is an electromagnetic shielding casing 9, as shown in FIG. 2, which is constituted by a display portion 10, and a main body 11 in which other kinds of electronic components are housed. A step portion 12 is formed between the display portion 10 and the main body 11. Further, a covering body formed of an electromagnetic shielding layer 13 is provided all over the surface of the external wall of the casing. Further, FIG. 3 shows an LC laminated composite electronic component 14, wherein a junction 17 is interposed between a capacitor 15 and an inductor 16, outer terminal electrodes 18 are provided at the opposite ends of the electronic component 14, and a ground side outer terminal electrode 19 of capacitor is provided at a central portion of the electronic component 14. Further, FIG. 4 shows a radiation noise preventing cable 20 which is constituted by a cable formed of covered conductor 21, and a sheath 22 formed on the outer circumferential wall of the cable. Further, FIG. 5 shows the external wall of building 23, which is constituted by electromagnetic shielding boards, panels or tiles 24, and packing bodies 25 formed of an electromagnetic shield coking material which is packed into the seam between the tiles 24.

A cured body of an electronic material composition composed of a resin material composition without including a powdery electronic material or other kinds of fillers may have the following physical properties.

(a) Glass transition temperature is confined within the range of −20 to 120° C.;
(b) Stiffness modulus at a temperature of not higher than the glass transition temperature thereof is confined within the range of 10⁸ Pa to 10¹¹ Pa;
(c) Stiffness modulus at a temperature of not lower than the glass transition temperature thereof is confined within the range of 10⁶ Pa to 10⁸ Pa;
(d) Critical breaking extensibility at a temperature of not higher than the glass transition temperature thereof is at least 3%; and
(e) Residual stress is not higher than 200 gf/mm².

A cured body of an electronic material composition composed of a resin material composition containing a powdery electronic material or other kinds of fillers together with the powdery electronic material may have the following physical properties.

(a)′ Glass transition temperature is confined within the range of −20 to 120° C.;
(b)′ Stiffness modulus at a temperature of not higher than the glass transition temperature thereof is confined within the range of 10⁸ Pa to 10¹⁰ Pa;
(c)′ Stiffness modulus at a temperature of not lower than the glass transition temperature thereof is confined within the range of 10⁶ Pa to 10⁸ Pa;
(d)′ Critical breaking extensibility at a temperature of not higher than the glass transition temperature thereof is at least 1.5%; and
(e)′ Residual stress is not higher than 200 gf/mm².

The glass transition temperatures (Tg) indicated in the aforementioned items (a) and (a)′ are obtained from changes in specific heat as measured by way of a temperature rising method using a differential scanning calorimeter (DSC). The stiffness modulus at a temperature of not higher than Tg in the aforementioned items (b) and (b)′ as well as the stiffness modulus at a temperature of not lower than Tg in the aforementioned items (c) and (c)′ are respectively a temperature-dependent value of stiffness modulus as measured by way of a temperature rising method using a rheometer.

Herein, with respect to the aforementioned changes in specific heat relative to temperature, the rate of change would become relatively large in the process of shifting from the state of glass to the state of rubber. On account of this large rate of change, the state of the electronic material composition can be distinguished from the state of glass or from the state of rubber where the rate of change is relatively small, respectively. The glass transition temperature, to be indicated by “Tg” is located within the range of temperature which corresponds to a changing curve portion where this large rate of change is exhibited.

As far as dynamic viscoelasticity is concerned, the storage elastic modulus (G′) representing the magnitude of the elastic factor of polymer is caused to decrease as the temperature thereof is raised. While G′ is continued to decrease even in the rubber region in the case of thermoplastic resins, G′ is not continued to decrease but plateaued or increased in the rubber region in the case of cross-linking type polymer. On the other hand, the relationship between temperature and the dynamic loss modulus (G″) representing the magnitude of the viscosity factor of polymer can be expressed by a curve having a maximum point. Further, the mechanical loss (loss tangent) tan δ (δ is a phase angle (a phase difference between stress and strain)) can be measured from the phase difference of simple harmonic oscillation between stress and strain. This mechanical loss represents a scale indicating the degree of loss, due to exothermic heat, of mechanical energy given to the system, wherein the temperature indicating a peak value of the curve G″ or tan δ corresponds to Tg (glass transition temperature) in the dynamic measurement. Accordingly, this temperature may be assumed as being the aforementioned glass transition temperature Tg. This Tg can be made higher by increasing the density of cross-linking or by designing the polymer so as to increase the density of nuclear structure such as phenyl nucleus. On the other hand, this Tg can be made lower by loosening the density of cross-linking or by introducing alkyl chains of fatty acid, polyether chains, or high-molecular chains of rubber for instance into the polymer. This Tg can be made lower also by incorporating a plasticizing agent into the polymer. Details of such techniques are available from a publication “The Latest Pigment Dispersion Technique” (1993, Technical Information Association, pp 53-54, paragraph 2.1).

In connection with the aforementioned properties (a) to (c) and (a)′ to (c)′, the cured body of epoxy resin which has been conventionally employed in the field of electronic material is generally such that the Tg thereof is higher than 50° C., the stiffness modulus in a state of rubber at a temperature of not lower than Tg is 10⁸ Pa or more, and the stiffness modulus in a state of glass at a temperature of not higher than Tg is confined within the range of 3×10⁸ Pa to 9×10⁹ Pa. On the other hand, the ordinary cross-linked rubber exhibiting high elasticity is generally low in Tg, i.e. not less than twice lower than −50° C. According to the present invention, an electronic material composition having the aforementioned properties of (a)′ to (c)′ and containing a large content of an inorganic filler (including a powdery electronic material) is employed as an electronic material, thereby providing a cured body with flexibility, tenacity, and resistance to thermal stress. By the way, the resin component to be employed in the present invention is curable, thus distinguishing it from thermoplastic resin component. By confining Tg to the aforementioned range, the electronic material composition is enabled to exhibit resistance and heat resistance even if it is placed in a condition where the temperature thereof is caused to change considerably in the aforementioned reflow soldering test, etc. Further, by also confining the stiffness modulus to the aforementioned range, the electronic material composition is enabled to exhibit not only the relaxation of thermal stress and mechanical stress but also shape retention.

As described above, the electronic material composition to be employed in the present invention is capable of exhibiting the aforementioned properties of (a)′ to (c)′ even the content of inorganic fillers is made relatively large. However, when this electronic material composition is provided additionally with the aforementioned properties of (d)′ and (e)′, this electronic material composition can be further distinguished from other kinds of materials.

The value of at least 1.5% indicated in the item (d)′ as a critical breaking extensibility is measured by making use of a strain-stress (S-S) curve according to the tensile test of cured body of an electronic material composition for packaging electronic component, this value indicating the external force absorbance, i.e. properties to absorb external force until the fracture of cured body is caused to occur. The cured body of epoxy resin which has been conventionally employed in the field of electronic material is generally such that the fracture of cured body is caused to occur due to a shear strain of 5% at a temperature of −50° C. and the critical breaking extensibility at a temperature of not higher than Tg is confined to the range of 0.5 to 5%. By contrast, in the case of the cured body of the electronic material composition to be employed in the present invention, the critical breaking extensibility thereof at a temperature of not higher than Tg is not less than 1.5, preferably not less than 5%, so that the critical breaking extensibility may exceed over 50%, thus distinguishing the present invention from the prior art in this respect also.

The value of not higher than 200 gf/mm² indicated in the item (e)′ is derived by measuring the strain by way of bimetal method. In the case of the cured body of epoxy resin to be employed in the field of electronic material according to the prior art, the residual stress at a temperature of 25° C. is confined within the range of 100 to 350 gf/mm². Whereas, in the case of the cured body of electronic material composition to be employed in the present invention, the residual stress can be confined to not more than 200 gf/mm², more preferably within the range of 0 to 150 gf/mm², most preferably to less than 100 gf/mm².

The same explanation as described above can be applied to the aforementioned items (d) and (e).

When one hundred of packaged chip type electronic components each sample having a packaging body consisting of a cured body of an electronic material composition having the properties (a) to (e) or (a)′ to (e)′ as described above were subjected to so-called heat cycle test wherein the packaged chip type electronic components were repeatedly placed in an atmosphere of −55° C. and +125° C. (one reciprocation between −55° C. and +125° C. was defined as one cycle), the generation of cracks in the packaging body was not recognized at all in any one of these samples even after 1000 cycles. Whereas, in the case of packaged chip type electronic components whose packaging body was formed of a cured body of the conventional composition using epoxy resin, the generation of cracks in the packaging body was recognized at a ratio of 40% (cracks recognized in 40 samples out of 100 samples, the same in the following description) after 100 cycles, this ratio of generating cracks being increased to 100% after 300 cycles.

By the way, in the case of the wound chip coil according to the present invention, since the packaging body portion of the wound chip coil, which corresponds to a portion to be adsorbed by the adsorption nozzle of a mounter is constituted by a soft polymer component of low elastic modulus, the packaging body is enabled to deform in conformity with the configuration of the contacting surface of the adsorption nozzle. As a result, there is no possibility of generating a gap between the packaging body portion and the adsorption nozzle, thus preventing the generation of slippage between the packaging body portion and the adsorption nozzle, and hence minimizing the generation of mis-mounting. After the mounting, the packaging body of the wound chip coil is enabled to restore the original configuration thereof, and hence there is no possibility of giving any disadvantage to the external appearance of electronic component.

Further, the electronic material composition according to the present invention is advantageous in various respects. For example, since the electronic material composition according to the present invention can be used with the polymer component thereof being kept in a semi-cured state, it is possible to control the heating temperature and heating time. As a result, electronic parts and electronic components to which the electronic material composition is applied can be prevented or suppressed from being thermally damaged in the heating step.

### EXAMPLES

Next, the present invention will be further explained with reference to the following examples. By the way, “part(s)” set forth in the following examples should be understood as “mass part(s)”.

### Example 1

The following components were mixed together by means of a roll mill or an agitation/dispersion machine to prepare a magnetic material composition.

(Components)

Acrylo-nitrile-butadiene rubber (CTBN) modified bisphenolic epoxy resin having carboxylic group (EPR-4023(15% CTBN solution); Asahi Denka Co., Ltd.)(chief material) 60-70 parts

Terminal carboxylic group modified polypropylene glycol (curing agent 1) 10-20 parts

Phenol novolac resin (PSM4261; Gunei Kagaku Co., Ltd.)(curing agent 2) 20-40 parts

Ferrite (M701(ferrite powder; Taiyou Yuden Co., Ltd.))(filler 1) 300-800 parts

Clay (quaternary ammonium cation-modified montmorillonite)(Benton 27; RHEOX, INC)(filler) 1-5 parts

Ultra-fine silica gel (RY200S; Nippon Aerogel Co., Ltd.)(filler 2) 3-8 parts

Trimethyl borate (additive) 0.4-0.8 parts

Epoxy resin amine adduct (imidazole type)(PN40; Ajinomoto Co., Inc.)(curing catalyst) 6-10 parts

2-butoxyethyl acetate (BGA; DAICEL Chemical Industries)(solvent 1) 30-35 parts

Petroleum hydrocarbon compound (solvesso 150; ESO Chemical Co., Ltd.)(solvent 2) 40-45 parts

By the way, the terminal carboxylic group modified polypropylene glycol was featured in that an average number of the terminal carboxylic group per molecule was four and weight average molecular weight (GPC method) was 2,500.

When the viscosity of aforementioned magnetic material composition was measured on two occasions, i.e. immediately after the manufacture thereof and after leaving it to stand for 14 days at the ordinary temperature under the condition of 25° C. by making use of a Brookfield type viscometer, the viscosity of the former occasion was 36 Pa, and the viscosity of the latter occasion was 36.6 Pa, indicating a rate of viscosity increase ([(latter−former)/former]×100%) of 1.7%.

Then, by making use of a nozzle, the aforementioned magnetic material composition was injected onto the winding 3 of the wound chip coil 1 shown in FIG. 1, allowed to dry and heated for 5 minutes in a curing oven at a temperature of 130° C. to allow the magnetic material composition to semi-cure. When the surface of this semi-cured coated layer was subjected to a dry tack test, this semi-cured coated layer was found acceptable.

Then, the article having this semi-cured coated layer was thrust into a recessed portion of mold or a plasmatic recessed portion formed in a silicone rubber plate, it was possible to thermally form this semi-cured coated layer without any portion of this coated layer being stripped away by the brim of the recessed portion of mold. After finishing the shaping step of this semi-cured coated layer, the resultant article was taken out of the mold, and the burr generated in the shaping step was removed. Thereafter, the resultant article was allowed to completely cure to obtain a completely cured article which was completely free from pinhole.

When this cured packaging body was measured with respect to the changes of specific heat by way of a temperature rising method using a differential scanning calorimeter (DSC), it was possible to confine the Tg thereof to the range of 0 to 60° C. Further, when the stiffness modulus of this cured packaging body was measured at a temperature of not higher than the Tg and at a temperature of not lower than the Tg by means of rheometer, the stiffness modulus was found 10⁸ to 10¹¹ Pa, and 10⁶ to 10⁸ Pa, respectively. Further, when the critical breaking extensibility of this cured packaging body was measured by making use of an S-S curve (stress-strain curve) according to the tensile test, it was found possible to confine the critical breaking extensibility to 2 to 50%. Furthermore, when the residual stress of this cured packaging body was measured by means of the bimetal method, it was found possible to confine the residual stress to 0 to 150 gf/mm².

Further, the residual stress of this cured packaging body was measured by means of the bimetal method (25° C.), and at the same time, the magnitude of inductance (L value) of this article was measured by making use of an LCR meter 4285A, thereby determining the rate of change of L [(Lₜ−L=ΔL)/L×100%(wherein L and Lₜ are a value of inductance before the packaging (residual stress=0) and after the packaging (the moment when the residual stress was generated), respectively)] relative to the magnitude of the residual stress. As a result, it was found possible to confine the rate of change of L to 0 to −5%.

When 100 pieces of wound chip coils packaged as described above were subjected to the heat cycle test wherein the chip coils were repeatedly placed in an atmosphere of −55° C. and +125° C. for 1000 cycles (one reciprocation between −55° C. and +125° C. was defined as one cycle), the generation of cracks was not recognized at all in the packaging body.

A magnetic material composition having the same composition as that of Example 1 except that 43.7 parts of the aforementioned solvent 2 was replaced by 43.7 parts of the aforementioned solvent 1 (total quantity of the solvent 1 was 75 parts) was employed and treated in the same manner as described in Example 1. As a result, the heating time required for making it acceptable in the dry tack test was extended to 15 minutes due to the nonuse of the solvent 2. However, since the ultra-fine silica gel was employed in this case, the properties thereof to the dry tack test was found more excellent as compared with that of a magnetic material composition having the same composition as that of Example 1 except that the ultra-fine silica gel was omitted in view of the relatively long heating time required for making the last-mentioned magnetic material composition acceptable in the dry tack test. With respect to other properties, the first mentioned magnetic material composition was almost the same as those of Example 1.

When a magnetic material composition having the same composition as that of Example 1 except that the filler 2 was not employed was employed and treated in the same manner as described in Example 1, it was impossible to prevent the generation of pinhole in contrast with the composition of Example 1. However, since the curing agent 1 was employed, the number of pinhole was far smaller as compared with that of a magnetic material composition having the same composition as that of Example 1 except that the aforementioned curing agent 1 was replaced by the aforementioned curing agent 2 (total quantity of the curing agent 2 was 32.8 parts)(Comparative Example 1 to be explained hereinafter). With respect to other properties, the first mentioned magnetic material composition was almost the same as those of Example 1.

When a magnetic material composition having the same composition as that of Example 1 except that the filler 3 was not employed was employed and treated in the same manner as described in Example 1, it was impossible to secure such a sufficient effect as obtainable with the composition of Example 1 in preventing the adhesion among the products after the shaping step thereof. With respect to other properties however, the first mentioned magnetic material composition was almost the same as those of Example 1.

When a magnetic material composition having the same composition as that of Example 1 except that the curing agent 2 was not employed was employed and treated in the same manner as described in Example 1, it was impossible to secure such a sufficient performance as obtainable with the composition of Example 1 in preventing the stripping-off of the packaging body by the brim of mold on the occasion of thrusting the packaging body into the mold. However, since the solvent 2 was employed, the performance of preventing the stripping-off of the packaging body was improved as compared with that of a magnetic material composition having the same composition as that of Example 1 except that the aforementioned solvent 2 was replaced by the solvent 1 (total quantity of the solvent 1 was 75 parts). With respect to other properties, the first mentioned magnetic material composition was almost the same as those of Example 1.

Even when a magnetic material composition having the same composition as that of Example 1 except that two kinds of components selected from the group consisting of the solvent 2, the filler 2, the filler 3 and the curing agent 2 were not employed was employed and that any of the residual components whose quantity was relatively large was supplemented with the same kind of component, the employment of this residual component was still meritorious. Namely, since at least the curing agent 1 was employed, any compositions mentioned above were meritorious even if all of the components mentioned above were not employed.

### Example 2

The following components were mixed together by means of a roll mill or an agitation/dispersion machine to prepare a magnetic material composition.

(Components)

Bisphenolic A epoxy resin (EPICLON 1055; Dai Nippon Ink Chemical Industries) (chief material) 40-55 parts

Terminal carboxylic group modified polypropylene glycol (curing agent 1) 40-60 parts

Phenol novolac resin (PSM4261; Gunei Kagaku Co., Ltd.)(curing agent 2) 30-35 parts

Ferrite (M701(ferrite powder; Taiyou Yuden Co., Ltd.))(filler 1) 200-500 parts

Ultra-fine silica gel (RY200S; Nippon Aerogel Co., Ltd.)(filler 2) 2-6 parts

Epoxy resin amine adduct (imidazole type)(PN40; Ajinomoto Co., Inc.)(curing catalyst) 2-12 parts

2-butoxyethyl acetate (BGA; Tokyo Kasei Co., Ltd.)(solvent 1) 50-70 parts

When the viscosity of aforementioned magnetic material composition was measured on two occasions, i.e. immediately after the manufacture thereof and after leaving it to stand for 14 days at the ordinary temperature under the condition of 25° C. by making use of a Brookfield type viscometer, the viscosity of the former occasion was 40 Pa, and the viscosity of the latter occasion was 41 Pa, indicating a rate of viscosity increase ([(latter−former)/former]×100%) of 2.5%.

Then, in the same manner as described in Example 1, by making use of a nozzle, the aforementioned magnetic material composition was injected onto the winding 3 of the wound chip coil 1 shown in FIG. 1, allowed to dry and heated for 8 minutes in a curing oven at a temperature of 130° C. to allow the magnetic material composition to semi-cure. When the surface of this semi-cured coated layer was subjected to a dry tack test, this semi-cured coated layer was found acceptable. Since the solvent 2 was not employed in this example, a longer heating time was required as compared with the case of Example 1. However, since the ultra-fine silica gel was employed in this case, the properties thereof to the dry tack test was found more excellent as compared with that of a magnetic material composition having the same composition as described above except that the ultra-fine silica gel was omitted and requiring a relatively long heating time for making it acceptable in the dry tack test.

Then, the article having this semi-cured coated layer was thrust into a recessed portion of mold or a plasmatic recessed portion formed in a silicone rubber plate, it was possible to thermally form this semi-cured coated layer without any portion of this coated layer being stripped away by the brim of the recessed portion of mold. After finishing the shaping step of this semi-cured coated layer, the resultant article was taken out of the mold, and the burr generated in the shaping step was removed. Thereafter, the resultant article was allowed to completely cure to obtain a completely cured article. Because of the fact that the filler 2 was not employed in this example, it was impossible, in this completely cured article, to prevent the generation of pinhole in contrast with the cured article of Example 1. However, since the curing agent 1 was employed, the number of pinhole was far smaller as compared with that of a magnetic material composition having the same composition as described above except that this curing agent 1 was replaced by the curing agent 2 (total quantity of the curing agent 2 was 32.8 parts)(Comparative Example 1 to be explained hereinafter). With respect to other properties, the first mentioned magnetic material composition was almost the same as those of Example 1.

When this cured packaging body was measured with respect to the changes of specific heat by way of a temperature rising method using a differential scanning calorimeter (DSC), it was possible to confine the Tg thereof to the range of −10 to 60° C. Further, when the stiffness modulus of this cured packaging body was measured at a temperature of not higher than the Tg and at a temperature of not lower than the Tg by means of rheometer, the stiffness modulus was found 10⁸ to 10¹¹ Pa, and 10⁶ to 10⁸ Pa, respectively. Further, when the critical breaking extensibility of this cured packaging body was measured by making use of an S-S curve (stress-strain curve) according to the tensile test, it was found possible to confine the critical breaking extensibility to 2 to 50%. Furthermore, when the residual stress of this cured packaging body was measured by means of the bimetal method, it was found possible to confine the residual stress to 0 to 150 gf/mm².

Further, the residual stress of this cured packaging body was measured by means of the bimetal method (25° C.), and at the same time, the magnitude of inductance (L value) of this article was measured by making use of an LCR meter 4285A, thereby determining the rate of change of L [(Lₜ−L=ΔL)/L×100%(wherein L and Lₜ are a value of inductance before the packaging (residual stress=0) and after the packaging (the moment when the residual stress was generated), respectively)] relative to the magnitude of the residual stress. As a result, it was found possible to confine the rate of change of L to 0 to −5%.

When 100 pieces of wound chip coils packaged as described above were subjected to the heat cycle test wherein the chip coils were repeatedly placed in an atmosphere of −55° C. and +125° C. for 1000 cycles (one reciprocation between −55° C. and +125° C. was defined as one cycle), the generation of cracks was not recognized at all in the packaging body.

### Example 3

An electronic material composition was prepared in the same manner as described in Example 1 except that the filler 1 was not employed. When this electronic material composition was treated and investigated in the same manner as described in Example 1, the completely cured body was completely free from pinhole.

When this cured packaging body was measured with respect to the changes of specific heat by way of a temperature rising method using a differential scanning calorimeter (DSC), it was possible to confine the Tg thereof to the range of 0 to 60° C. Further, when the stiffness modulus of this cured packaging body was measured at a temperature of not higher than the Tg and at a temperature of not lower than the Tg by means of rheometer, the stiffness modulus was found 10⁸ to 10⁹ Pa, and 10⁶ to 10⁸ Pa, respectively. Further, when the critical breaking extensibility of this cured packaging body was measured by making use of an S-S curve (stress-strain curve) according to the tensile test, it was found possible to confine the critical breaking extensibility to 10 to 100%. Furthermore, when the residual stress of this cured packaging body was measured by means of the bimetal method, it was found possible to confine the residual stress to 0 to 150 gf/mm².

Further, the residual stress of this cured packaging body was measured by means of the bimetal method (25° C.), and at the same time, the magnitude of inductance (L value) of this article was measured by making use of an LCR meter 4285A, thereby determining the rate of change of L [(Lₜ−L=ΔL)/L×100%(wherein L and Lₜ are a value of inductance before the packaging (residual stress=0) and after the packaging (the moment when the residual stress was generated), respectively)] relative to the magnitude of the residual stress. As a result, it was found possible to confine the rate of change of L to 0 to −5%.

When 100 pieces of wound chip coils packaged as described above were subjected to the heat cycle test wherein the chip coils were repeatedly placed in an atmosphere of −55° C. and +125° C. for 1000 cycles (one reciprocation between −55° C. and +125° C. was defined as one cycle), the generation of cracks was not recognized at all in the packaging body.

### Comparative Example 1

An electronic material composition was prepared in the same manner as described in Example 1 except that the curing agent 1 was not employed and the curing agent 2 was employed instead (total quantity of the curing agent 2 was 32.8 parts). Then, various features of the electronic material composition were investigated.

As a result, the rate of viscosity increase of the electronic material composition was 100%, so that it was impossible to use the electronic material composition as one-pack system. Further, the heating time required for making the electronic material composition acceptable in the dry tack test was as long as 15 minutes. Further, as compared with the composition of Example 1, the handling properties of the electronic material composition was inferior, and the stripping of the packaging body by the brim of mold was also recognized on the occasion of thrusting the packaging body into the mold. Further, the generation of pinhole was also recognized in the completely cured body.

When this cured packaging body was measured with respect to the changes of specific heat by way of a temperature rising method using a differential scanning calorimeter (DSC), the Tg thereof was found to fall within the range of 100 to 150° C. Further, when the stiffness modulus of this cured packaging body was measured at a temperature of not higher than the Tg and at a temperature of not lower than the Tg by means of rheometer, the stiffness modulus was found 10⁸ to 10¹¹ Pa, and 10⁶ to 10⁸ Pa, respectively. Further, when the critical breaking extensibility of this cured packaging body was measured by making use of an S-S curve (stress-strain curve) according to the tensile test, the critical breaking extensibility was found 0.4%. Furthermore, when the residual stress of this cured packaging body was measured by means of the bimetal method, the residual stress was found to range from 300 to 600 gf/mm².

Further, the residual stress of this cured packaging body was measured by means of the bimetal method (25° C.), and at the same time, the magnitude of inductance (L value) of this article was measured by making use of an LCR meter 4285A, thereby determining the rate of change of L [(Lₜ−L=ΔL)/L×100%(wherein L and Lₜ are a value of inductance before the packaging (residual stress=0) and after the packaging (the moment when the residual stress was generated), respectively)] relative to the magnitude of the residual stress. As a result, the rate of change of L was found −10%.

When 100 pieces of wound chip coils packaged as described above were subjected to the heat cycle test wherein the chip coils were repeatedly placed in an atmosphere of −55° C. and +125° C. for 1000 cycles (one reciprocation between −55° C. and +125° C. was defined as one cycle), the generation of cracks was found in 100 pieces of the packaging body.

### Industrial Applicability

According to the present invention, since a terminal carboxylic group modified polyether compound is employed in an electronic material composition, even if the electronic material composition is employed as one-pack type, the changes with time of viscosity would be confined to such a degree that would not bring about any substantial problem in practical use, and at the same time, even if the electronic material composition is exposed to fluctuations in ambient temperature, there is little possibility of generating cohesive failure or peeling fracture. As a result, it is now possible to enhance the handling properties of the electronic material composition in a packaging step, etc. without any possibility of giving damage to the external appearance. Therefore, it is now possible, according to the present invention, to provide an electronic material composition which is capable of substantially preventing, even if the content of an inorganic filler in a cured coated layer is increased, the deterioration of magnetic/electric properties that can be improved through the provision of a packaging body to an electronic device, an electronic device to be obtained through the employment of this electronic material composition, and a method of using this electronic material composition.

1. An electronic material composition comprising:
an epoxy-based curable resin having epoxy group; and
a terminal carboxylic group modified polyether compound acting as a curable component which is capable of reacting with said epoxy group.

2. An electronic material composition comprising:
a butadiene-based polymer modified epoxy resin having carboxylic group as an epoxy-based curable resin having epoxy group; and
a terminal carboxylic group modified polyether compound acting as a curable component which is capable of reacting with said epoxy group.

3. The electronic material composition according to claim 1, further comprises ultra-fine silica gel powder.

4. The electronic material composition according to claim 1, wherein an epoxy curing agent which is different from the terminal carboxylic group modified polyether compound is included as the curable component.

5. The electronic material composition according to claim 4, wherein said epoxy curing agent is phenol novolac resin.

6. The electronic material composition according to claim 1, further comprises electronic material powder.

7. The electronic material composition according to claim 6, wherein said electronic material powder is magnetic powder.

8. The electronic material composition according to claim 1, wherein a formed body to be obtained through application of an electronic material composition to an electronic product is: a molded body made of a molding material; a filler body made of a filler material; a covering body made of a covering material; an electrode made of an electrode material; or a junction body made of a junction material.

9. An electronic product comprising the molded body, the filler body, the covering body, the electrode, or the junction body as set forth in claim 8.

10. The electronic product according to claim 9, wherein said electronic product is a wound chip coil having a packaging body, and said covering body is the packaging body applied onto and covering a winding of wound chip coil.

11. A method of using an electronic material composition, wherein the electronic material composition as set forth in claim 1 is used and set to a semi-cured state to obtain an electronic product having a semi-cured molded body, filler body, covering body, electrode, or junction body, and then the electronic material composition is completely cured to obtain an electronic product having a cured molded body, filler body, covering body, electrode, or junction body.

12. The method of using an electronic material composition according to claim 11, wherein the electronic product having a semi-cured covering body is allowed to dry to a state of dry to touch and then thermally shaped by making use of a mold to obtain the electronic product having a cured packaging body.

13. The method of using an electronic material composition according to claim 12, wherein the electronic product having a semi-cured covering body is formed using an electronic material composition containing an ester-based solvent and a petroleum solvent at a ratio ranging from 0:100% to 100:0% by mass.

14. The electronic material composition according to claim 2, further comprises ultra-fine silica gel powder.

15. The electronic material composition according to claim 2, wherein an epoxy curing agent which is different from the terminal carboxylic group modified polyether compound is included as the curable component.

16. The electronic material composition according to claim 3, wherein an epoxy curing agent which is different from the terminal carboxylic group modified polyether compound is included as the curable component.

17. The electronic material composition according to claim 14, wherein an epoxy curing agent which is different from the terminal carboxylic group modified polyether compound is included as the curable component.

18. The electronic material composition according to claim 2, further comprises electronic material powder.

19. The electronic material composition according to claim 3, further comprises electronic material powder.

20. The electronic material composition according to claim 14, further comprises electronic material powder.
